(19) United States
(12) Patent Application Publication
(10) Pub. No.: US 2026/0108863 A1
(43) Pub. Date: Apr. 23, 2026

(54) ADSORBENT FOR SIMULTANEOUS REMOVAL OF HEAVY METAL LEAD AND PRECIOUS METAL GOLD, PREPARATION METHOD AND APPLICATION

(71) Applicant: East China University of Science and Technology, Shanghai (CN)

(72) Inventors: Chengcheng Tian, Shanghai (CN); Li'an Zou, Shanghai (CN); Haiping Fang, Shanghai (CN); Hualin Wang, Shanghai (CN)

(21) Appl. No.: 19/361,601

(22) Filed: Oct. 17, 2025

(30) Foreign Application Priority Data
Oct. 21, 2024 (CN) 202411470335X

(51) Int. Cl. B01J 20/22; B01J 20/30; C02F 1/28; C02F 101/20

(52) U.S. Cl. CPC B01J 20/22; B01J 20/3021; B01J 20/3071; C02F 1/286; C02F 2101/20

(57) ABSTRACT

An adsorbent for simultaneous removal of heavy metal lead and precious metal gold, a preparation method and an application are provided, and relate to the technical field of environmental functional materials, solving problems of high cost and secondary pollution in adsorbent preparation for heavy metal adsorption materials. The method includes: collecting and pre-processing leaves to obtain pre-processed leaves, and irradiating the pre-processed leaves with ultraviolet light to obtain irradiated leaves; drying the irradiated leaves by freeze-drying or vacuum drying to obtain dried leaves; and ball milling the dried leaves by using a ball mill at a ball milling frequency in a range of 10-40 Hz for 10-120 min to obtain leaf powder as the adsorbent. The preparation process of the adsorbent does not require solvents. The adsorbent is prepared by ball-milling leaves combined with ultraviolet irradiation and freeze-drying. The process is simple, environmentally friendly, and suitable for large-scale production.

### TECHNICAL FIELD

The disclosure relates to the technical field of environmental functional materials, and more particularly to an adsorbent for simultaneous removal of heavy metal lead and precious metal gold, a preparation method and an application.

### BACKGROUND

In a process of modern industrialization and urbanization, the pollution of heavy metals and precious metals has become a global concern. The main sources of lead ion pollution are battery manufacturing, smelting, fertilizers, and fuels. People who are exposed to lead pollution for a long time may suffer from neurological damage, cognitive decline, and other health problems, and the lead pollution also poses a serious threat to the ecological environment. Lead ion emissions can affect soil fertility and microbial activity, thereby affecting plant growth and ecosystem stability. The lead ion pollution in water bodies can endanger the survival of aquatic organisms and disrupt the balance of aquatic ecosystems. At the same time, metal recycling is also of great significance in terms of resource conservation and economic benefits, especially the recycling of precious metals such as gold, which is crucial for reducing mineral resource extraction and environmental destruction.

Traditional methods for removing metals from aqueous solutions can be divided into three major categories: physical, chemical, and biological methods, including chemical precipitation, chemical oxidation/reduction, ion exchange, filtration, electrochemical treatment, reverse osmosis, membrane technology, and evaporation recovery. The precipitation method has broad application prospects among many technologies due to its simplicity and cost-effectiveness. At present, a variety of adsorbents have been developed, and their removal performance has been studied. However, most adsorbents, such as activated carbon, clay and zeolite, and metal-organic framework (MOF) materials, are expensive, generate secondary waste, and require technical treatment of chemicals and complex infrastructure. For example, depending on the type of precipitant, the removal rate of lead ions by the chemical precipitation ranges from 70% to 90%. The removal rate of common commercial carbon materials is usually around 85%, while the removal rate of the MOF materials with broad-spectrum adsorption capabilities can reach 99%. However, due to the high cost of the MOF materials, their application in water treatment is severely limited. For metal recycling, the related art such as cyanidation and electrolysis, although showing high recovery rates under laboratory conditions, are limited in practical applications due to environmental pollution, economic costs, and operational complexity, making it difficult to promote the cyanidation and the electrolysis on a large scale. In particular, the environmental safety hazards of cyanidation limit the application of the cyanidation. Therefore, the development of an environmentally friendly adsorbent that is simple to prepare, has abundant raw materials, and can efficiently and quickly remove heavy metal lead and adsorb and recover precious metal gold has important application value.

### SUMMARY

A first purpose of the disclosure is to provide a method for preparing an adsorbent that can remove heavy metal lead and precious metal gold individually or simultaneously. The method aims to address issues of preparation loading, high cost, and secondary pollution associated with heavy metal adsorbents. The preparation process does not require the addition of solvents, and includes ball-milling of leaves combined with ultraviolet irradiation and freeze-drying. This method is simple, environmentally friendly, and suitable for large-scale production.

In order to achieve the purposes, the disclosure adopts the following technical solutions.

A method for preparing an adsorbent for simultaneous removal of heavy metal lead and precious metal gold includes:

step 1, collecting and pre-processing leaves to obtain pre-processed leaves, and irradiating the pre-processed leaves with ultraviolet light with a wavelength in a range of 190-400 nanometers (nm) for 12-48 hours (h) to obtain irradiated leaves;

step 2, drying the irradiated leaves obtained in step 1 by freeze-drying or vacuum drying to obtain dried leaves; and

step 3, ball milling the dried leaves obtained in step 2 by using a ball mill at a ball milling frequency in a range of 10-40 Hertz (Hz) for 10-120 minutes (min) to obtain leaf powder as the adsorbent.

In an embodiment, in step 1, the leaves are selected from summer leaves or winter leaves. The pre-processing leaves includes: washing and cutting the leaves to obtain the pre-processed leaves of uniform size.

In an embodiment, the leaves are selected from the summer leaves.

In an embodiment, in step 1, the ultraviolet light includes ultraviolet A rays with a wavelength in a range of 315-400 nm, ultraviolet B rays with a wavelength in a range of 280-315 nm, or ultraviolet C rays with a wavelength in a range of 190-280 nm; and irradiating time is in a range of 20-24 h.

In an embodiment, the irradiating the pre-processed leaves with ultraviolet light with a wavelength in a range of 190-400 nm includes: irradiating the pre-processed leaves with the ultraviolet B rays with the wavelength in a range of 280-315 nm.

In an embodiment, in step 2, the freeze-drying includes immersing the irradiated leaves in liquid nitrogen for drying, a temperature for the vacuum drying is in a range of 40-100°C, and drying time is in a range of 10-12 h; and a moisture content of the dried leaves is ≤ 5%.

In an embodiment, in step 3, the ball milling frequency is in a range of 15-20 Hz, and ball milling time is in a range of 10-60 min.

A second purpose of the disclosure is to provide an adsorbent prepared by the above method.

A third purpose of the disclosure is to provide an application method of the adsorbent, including:

adding the adsorbent to an aqueous solution containing the heavy metal lead and the precious metal gold, where a dosage of the adsorbent is in a range of 1-10 grams per liter (g/L), an initial pH value of the aqueous solution is in a range of 2-7, a pH value of the aqueous solution for removing lead ions is in a range of 5-6, a pH value of the aqueous solution for removing gold ions is in a range of 2-3, and initial concentrations of the lead ions and the gold ions in the aqueous solution are individually in a range of 100-800 milligrams per liter (mg/L).

In an embodiment, the initial concentrations of the lead ions and the gold ions in the aqueous solution are individually 200 mg/L, and a temperature of the aqueous solution is 10-100°C. The application method further includes: stirring at a speed in a range of 200-1000 revolutions per minute (r/min) when adding the adsorbent to the aqueous solution.

The preparation mechanism of the adsorbent of the disclosure is as follows.

By combining ultraviolet irradiation and freeze-drying, a simple and green ball milling method is used to obtain universal leaf powder. The results show that the ball-milled leaf powder has excellent adsorption capacity and can effectively remove heavy metal ions. The removal rate of single-component lead ions by the ball-milled leaf powder reaches over 99%, and the adsorption effect on the gold ions also reaches over 99%. Research has found that there is a strong interaction between the aromatic ring structure in the leaves and the heavy metal ions, and this interaction is the key for the leaf powder to achieve rapid adsorption and efficient removal of heavy metal ions. The aromatic rings in the leaves provide abundant π-electrons and oxygen-containing functional groups, which can form pocket structures with heavy metal ions, thereby enhancing the adsorption performance. In summary, the adsorption characteristics of the leaf powder provide a green and efficient solution for removing heavy metal pollution.

Compared with the related art, the disclosure brings the following beneficial technical effects.

(1) The disclosure proposes the method for preparing an adsorbent for simultaneous removal of heavy metal lead and precious metal gold. This method is simple to operate and cost-effective, and provides a new application pathway for ordinary leaves as a natural biomass material. Specifically, the preparation process is simple and does not require the use of chemical reagents. The raw materials are inexpensive and readily available. The ultraviolet irradiation improves the surface properties of the leaves, and the freeze-drying maintains the microstructure of the lignin in the material. The adsorbent of the disclosure can not only efficiently remove the heavy metal lead from the aqueous solution but also effectively adsorb and recover the precious metal gold. The adsorbent has broad application prospects in the treatment of heavy metal-polluted water bodies and the recovery of precious metals.

(2) The adsorbent prepared by the disclosure can effectively adsorb lead and gold in water simultaneously. Specifically, in a mixed solution with an initial concentration of 200 mg/L for both lead ions (Pb²⁺ or Pb (II)) and gold ions (Au³⁺ or Au (Ⅲ)), the adsorbent reaches equilibrium within 10 seconds at the beginning of the reaction, achieving adsorption on a timescale of seconds. At the same time, the removal rate of lead reaches as high as 95%, and the removal rate of gold reaches as high as 90%, realizing efficient and rapid adsorption.

(3) The adsorbent prepared by the disclosure can be used repeatedly for up to 30 cycles while still maintaining a high removal rate. This further proves that the adsorbent prepared by the disclosure has good durability and cost-effectiveness.

### BRIEF DESCRIPTION OF DRAWINGS

FIG. 1 illustrates a flowchart diagram for preparing an adsorbent of the disclosure.

FIGS. 2A-2B respectively illustrate scanning electron microscopy (SEM) diagrams of the adsorbent prepared in an embodiment 1 of the disclosure.

FIG. 3 illustrates a test result diagram of effects of adsorbents prepared with different ultraviolet lights on heavy metal lead according to the embodiment 1 of the disclosure.

FIG. 4 illustrates a test result diagram of effects of adsorbents prepared with different leaves on the heavy metal lead according to the embodiment 1 of the disclosure.

FIG. 5A illustrates a test result diagram of effects of different dosages of the adsorbent on adsorption of the heavy metal lead according to an embodiment 2 of the disclosure, and FIG. 5B illustrates a test result diagram of effects of different dosages of the adsorbent on adsorption of the precious metal gold.

FIG. 6A illustrates a test result diagram of effects of different ion concentrations on the adsorption of the heavy metal lead according to the embodiment 2 of the disclosure, and FIG. 6B illustrates a test result diagram of effects of different ion concentrations on the adsorption of the precious metal gold.

FIG. 7A illustrates a test result diagram of effects of different reaction solution pH values on the adsorption of the heavy metal lead according to the embodiment 2 of the disclosure, and FIG. 7B illustrates a test result diagram of effects of the different reaction solution pH values on the adsorption of the precious metal gold.

FIG. 8A illustrates a test result diagram of effects of different reaction times on the adsorption of the heavy metal lead according to an embodiment 3 of the disclosure, and FIG. 8B illustrates a test result diagram of effects of the different reaction times on the adsorption of the precious metal gold.

FIG. 9 illustrates a test result diagram of a cyclic adsorption effect of the heavy metal lead according to an embodiment 4 of the disclosure.

FIG. 10 illustrates a test result diagram of an adsorption effect of heavy metal lead and precious metal gold coexistence according to an embodiment 5 of the disclosure.

### DETAILED DESCRIPTION OF EMBODIMENTS

The following will provide a clear and complete description of the technical solution in the embodiments of the disclosure, in conjunction with the accompanying drawings.

In the description of the disclosure, unless otherwise specified, “/” means “or”, for example, A/B can represent A or B. The “and/or” herein is only a description of the association relationship between related objects, indicating that there can be three types of relationships, for example, A and/or B, which can indicate: A exists alone, A and B exist simultaneously, and B exists alone.

Below, a further detailed description of the technical solution of the disclosure will be provided in conjunction with the accompanying drawings.

The raw materials mentioned in the disclosure can be purchased through commercial channels.

### Embodiment 1

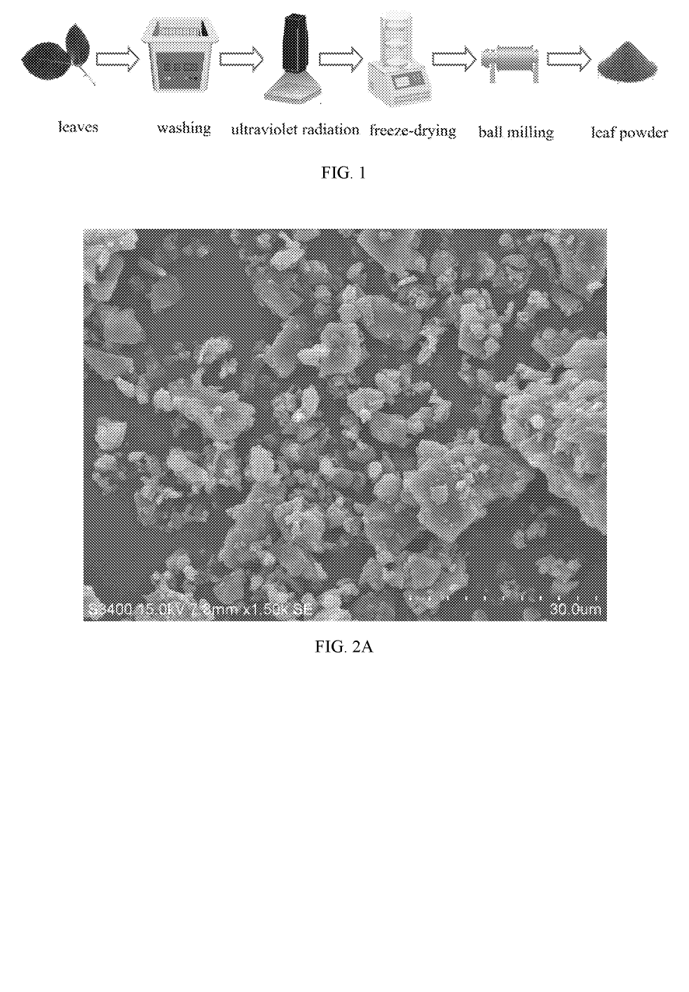

As shown in FIG. 1, the disclosure provides a method for preparing an adsorbent for simultaneous removal of heavy metal lead and precious metal gold includes the following steps.

Step 1, collected leaves are washed with deionized water to obtain washed leaves, and the washed leaves are cut into small pieces of similar size using a scissor and then placed under ultraviolet lamps of different wavelengths for irradiation, with ultraviolet A rays (315-400 nm), and irradiation time set at 24 h to obtain irradiated leaves.

Step 2, the irradiated leaves are dried by freeze-drying for 12 h to obtain dried leaves.

Step 3, the dried leaves are ball-milled using a high-speed vibratory ball mill at a frequency of 20 Hz for 120 min to obtain the adsorbent.

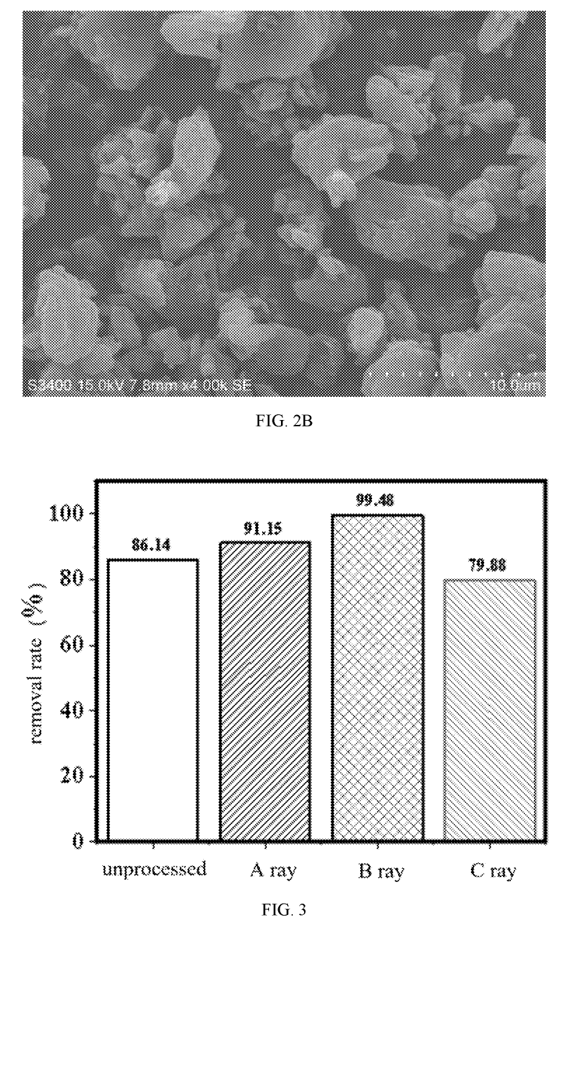

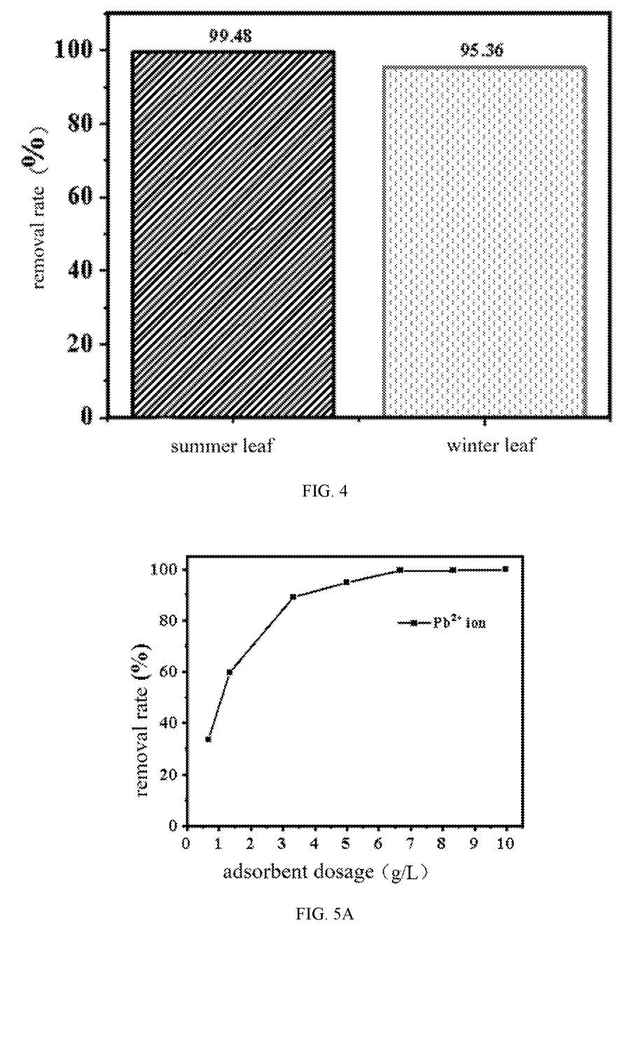

The SEM images of the adsorbent prepared in this embodiment 1 are shown in FIGS. 2A-2B. As can be seen from FIGS. 2A-2B, a surface of the adsorbent is smooth and lacks obvious porous structures.

### Embodiment 2

The disclosure provides a method for preparing an adsorbent for simultaneous removal of heavy metal lead and precious metal gold includes the following steps.

Step 1, collected leaves are washed with deionized water to obtain washed leaves, and the washed leaves are cut into small pieces of similar size using a scissor and then placed under ultraviolet lamps of different wavelengths for irradiation, with ultraviolet B rays (280-315 nm), and irradiation time set at 20 h to obtain irradiated leaves.

Step 2, the irradiated leaves are dried by freeze-drying for 10 h to obtain dried leaves.

Step 3, the dried leaves are ball-milled using a high-speed vibratory ball mill at a frequency of 15 Hz for 30 min to obtain the adsorbent.

### Embodiment 3

The disclosure provides a method for preparing an adsorbent for simultaneous removal of heavy metal lead and precious metal gold includes the following steps.

Step 1, collected leaves are washed with deionized water to obtain washed leaves, and the washed leaves are cut into small pieces of similar size using a scissor and then placed under ultraviolet lamps of different wavelengths for irradiation, with ultraviolet C rays (190-280 nm), and irradiation time set at 22 h to obtain irradiated leaves.

Step 2, the irradiated leaves are dried by freeze-drying for 11 h to obtain dried leaves.

Step 3, the dried leaves are ball-milled using a high-speed vibratory ball mill at a frequency of 18Hz for 50 min to obtain the adsorbent.

The adsorption performance of the adsorbents prepared in the embodiments 1-3 is compared, as shown in FIG. 3. The adsorbent irradiated with the ultraviolet B rays (280-315 nm) exhibits the best adsorption performance. The improvement in adsorption performance with the ultraviolet A rays is not significantly different from that of a non-irradiated sample (i.e., unprocessed sample). The excessive energy of the ultraviolet C rays causes structural damage to the adsorbent, resulting in poor performance. The results indicate that appropriate ultraviolet irradiation can enhance the adsorption capacity of the adsorbent.

### Embodiment 4

The disclosure provides a method for preparing an adsorbent for simultaneous removal of heavy metal lead and precious metal gold includes the following steps.

Step 1, collected summer leaves are washed with deionized water to obtain washed leaves, and the washed leaves are cut into small pieces of similar size using a scissor and then placed under ultraviolet lamps of different wavelengths for irradiation, with ultraviolet B rays (280-315 nm) and irradiation time set at 20 h to obtain irradiated leaves.

Step 2, the irradiated leaves are dried by freeze-drying for 10 h to obtain dried leaves.

Step 3, the dried leaves are ball-milled using a high-speed vibratory ball mill at a frequency of 15 Hz for 10 min to obtain the adsorbent.

### Embodiment 5

The difference from the embodiment 4 is that: winter leaves are used as the raw material.

The adsorbents prepared in the embodiments 4 and 5 are tested. As shown in FIG. 4, adsorbents prepared from different types of leaves are used to adsorb and remove lead ions from water. The results indicate that the adsorbents prepared from the summer leaves and the winter leaves have similar performance in the removal rate of lead ions, both exceeding 95%. Among them, the adsorbent prepared from the summer leaves performs the best, with a removal rate reaching 99%. These results demonstrate that ordinary leaves can be effectively used to prepare a highly efficient adsorbent for the excellent removal and recovery of heavy metal lead and precious metal gold.

### Embodiment 6

The performance of the adsorbent prepared in the embodiment 1 is tested, focusing on the efficient removal of heavy metal lead.

The dosage of the adsorbent, the concentration of the metal ions, and the pH value of the adsorption solution are used as control targets, with the following results.

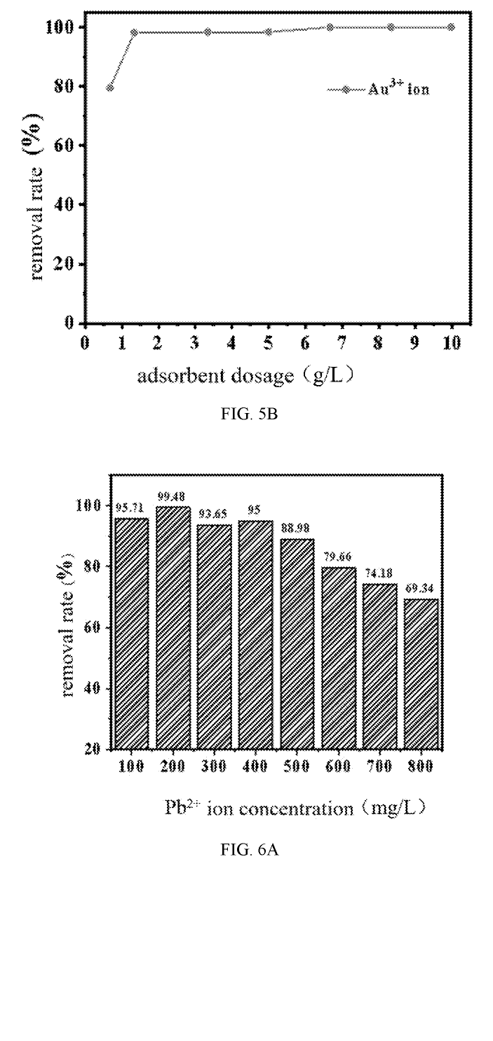

(1) As shown in FIG. 5A, the effects of different dosages of the adsorbent on the removal rate of lead ions are studied. The results show that the removal rate of lead ions gradually increases with the increase in the dosage of the adsorbent. When the dosage of the adsorbent exceeds 6 g/L, the removal rate tends to saturate and approaches 100%. As shown in FIG. 5B, the effect of changing the adsorbent dosage on the recovery of gold ions is also studied. The results show that the removal rate of gold ions gradually increases with the increase in the dosage of the adsorbent. When the dosage of the adsorbent exceeds 1 g/L, the removal rate saturates and approaches 100%. These results indicate that adjusting the dosage of the adsorbent can effectively optimize the removal and recovery of lead ions and gold ions.

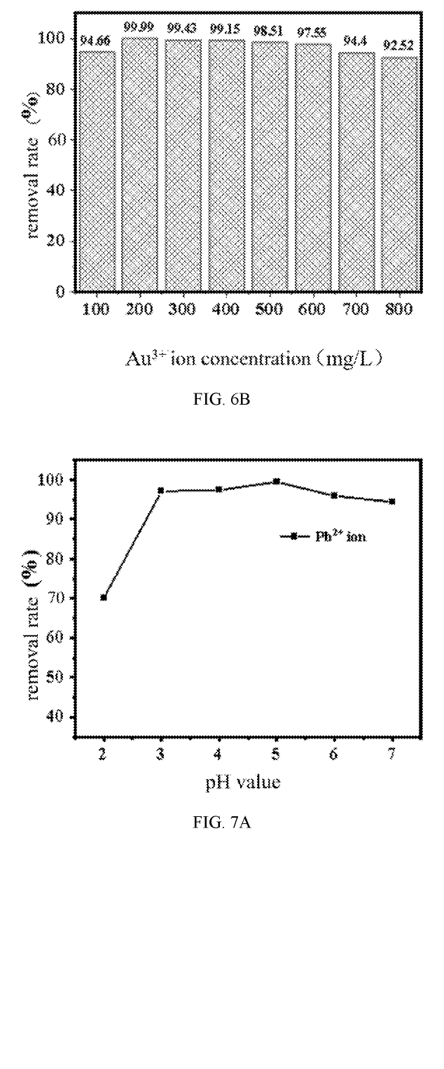

(2) As shown in FIGS. 6A-6B, the effects of varying concentrations of lead/gold ions in a range of 100-800 mg/L on the removal rate are studied, while keeping the adsorbent dosage constant. Under the same adsorption time conditions, the results show that the removal rate initially increases and then decreases as the concentration of lead/gold ions increases, presenting a volcano-shaped curve. The optimal concentration for lead/gold ions is 200 mg/L, at which the removal rate reaches the optimal level.

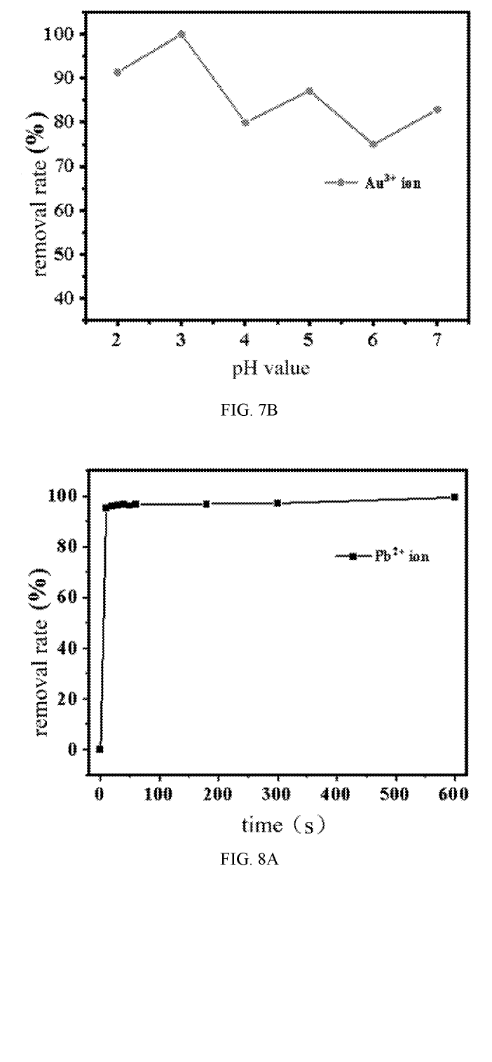

(3) As shown in FIG. 7A, within the pH range of 2 to 7, the removal rate of lead ions gradually increases with the pH value increase. The removal rate is the lowest when the pH value is 2, while the best removal effect of lead ions is achieved when the pH value is in a range of 5-6. Similarly, as shown in FIG. 7B, within the same pH range, the removal rate of gold ions increases at a pH of 2-3. As the pH value further increases, the removal rate exhibits a fluctuating downward trend, with an overall decrease. Ultimately, the optimal pH range for the adsorption and recovery of precious metal gold is determined to be 2-3.

After the screening experiments mentioned above, the optimal adsorption conditions for heavy metal lead and precious metal gold have been determined. For the adsorption and removal of heavy metal lead, the optimal conditions are as follows: the adsorbent dosage is greater than 6 g/L, the concentration of lead ions is 200 mg/L, and the pH value of the reaction solution is in a range of 5-6. For the adsorption and recovery of precious metal gold, the optimal conditions are as follows: the adsorbent dosage is greater than 1 g/L, the concentration of gold ions is 200 mg/L, and the pH value of the reaction solution is in a range of 2-3.

### Embodiment 7

The effects of different reaction times on the adsorption of heavy metal lead and precious metal gold are as follows.

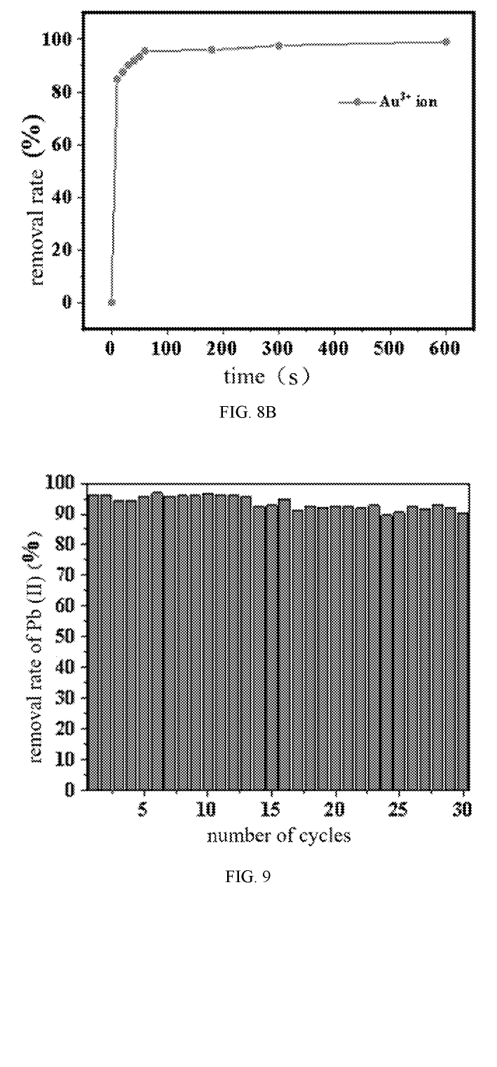

In this embodiment, the adsorbent with a dosage greater than 6 g/L is added to a solution containing 200 mg/L of lead ions with a pH value of 5-6, and the reaction is performed at 25℃ and 500-800 r/min. Samples are taken and filtered at different time points (2, 5, 10, 20, 30, 40, 50, 60, 180, 300, 600 seconds) to measure the concentrations of lead ions in the filtrates. As shown in FIG. 8A, the removal rate of lead ions reaches as high as 96% at 60 seconds, indicating that in the initial stage of the reaction, the adsorption efficiency of the adsorbent for lead ions is extremely high and nearly complete, after which the system tends to equilibrium.

The adsorbent with a dosage greater than 1 g/L is added to a solution containing 200 mg/L of gold ions with a pH value of 2-3, and the reaction is performed at 25℃ and 500 r/min. Samples are taken and filtered at different time points (2, 5, 10, 20, 30, 40, 50, 60, 180, 300, 600 seconds) to measure the concentrations of gold ions in the filtrates. As shown in FIG. 8B, the adsorption recovery rate of gold ions reaches as high as 93% at 60 seconds, indicating that in the initial stage of the reaction, the adsorption efficiency of the adsorbent for gold ions is extremely high and nearly complete, after which the system tends to equilibrium.

The above experimental results show that the adsorbent has a rapid adsorption and recovery effect on heavy metal lead and precious metal gold.

### Embodiment 8

This embodiment tests the adsorption effect of the coexistence of heavy metal lead and precious metal gold.

As shown in FIG. 9, the adsorbent exhibits excellent stability during multiple cycles of use, maintaining a high removal efficiency even after 30 cycles. This indicates that the adsorbent efficiently removes heavy metals and has good durability and cost-effectiveness, effectively addressing the issues of loading, cost, and secondary pollution associated with traditional materials and significantly enhancing the professionalism and sustainability of heavy metal treatment.

### Embodiment 9

This embodiment tests the adsorption effect in the coexistence of heavy metal lead and precious metal gold.

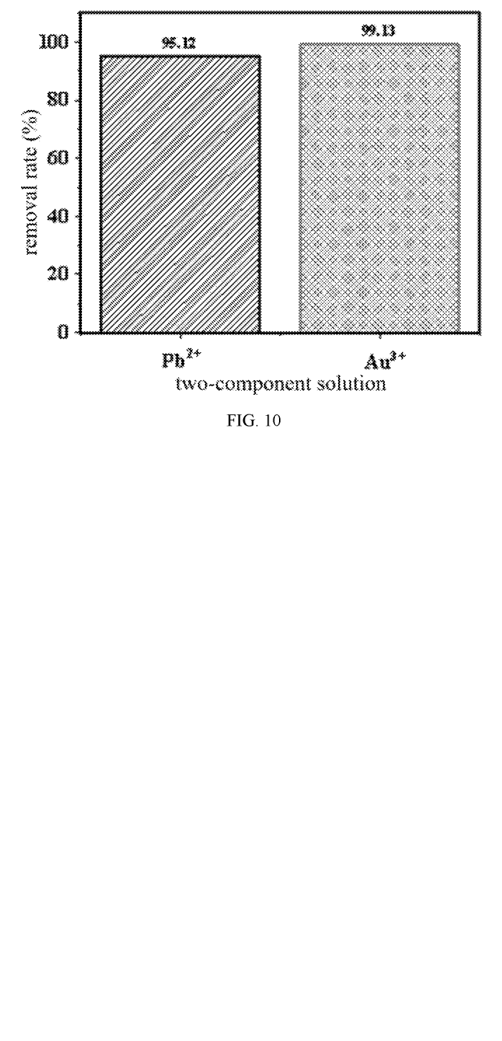

This embodiment mainly shows that the adsorption of single-component metal ions and the coexistence of two-component metal ions have different effects. As shown in FIG. 10, the adsorption removal rate of lead/gold ions is greater than 99% in the single-component solution. When the heavy metal lead and the precious metal gold coexist, the adsorption rate of lead ions drops slightly to 95%, while the adsorption recovery rate of gold ions remains high, at more than 99%. It can be seen that the coexistence has little effect on the adsorbent. This suggests that the adsorbent can effectively treat water contaminated with multiple heavy metals simultaneously.

The parts not mentioned in the disclosure can be implemented by drawing on the related art.

It should be noted that those skilled in the art should recognize that the above embodiments are only used to illustrate the disclosure and not to limit the disclosure. As long as they are within the substantive spirit of the disclosure, appropriate changes and variations made to the above embodiments should fall within the scope of protection of the claims of the disclosure.

WHAT IS CLAIMED IS:

1. A method for preparing an adsorbent for simultaneous removal of heavy metal lead and precious metal gold, comprising:
step 1, collecting and pre-processing leaves to obtain pre-processed leaves, and irradiating the pre-processed leaves with ultraviolet light with a wavelength in a range of 190-400 nanometers (nm) for 12-48 hours (h) to obtain irradiated leaves;
step 2, drying the irradiated leaves obtained in step 1 by freeze-drying or vacuum drying to obtain dried leaves; and
step 3, ball milling the dried leaves obtained in step 2 by using a ball mill at a ball milling frequency in a range of 10-40 Hertz (Hz) for 10-120 minutes (min) to obtain leaf powder as the adsorbent.

2. The method as claimed in claim 1, wherein in step 1, the leaves are selected from summer leaves or winter leaves, and
wherein the pre-processing leaves comprises: washing and cutting the leaves to obtain the pre-processed leaves of uniform size.

3. The method as claimed in claim 2, wherein the leaves are selected from the summer leaves.

4. The method as claimed in claim 1, wherein in step 1, the ultraviolet light comprises ultraviolet A rays with a wavelength in a range of 315-400 nm, ultraviolet B rays with a wavelength in a range of 280-315 nm, or ultraviolet C rays with a wavelength in a range of 190-280 nm; and irradiating time is in a range of 20-24 h.

5. The method as claimed in claim 4, wherein the irradiating the pre-processed leaves with ultraviolet light with a wavelength in a range of 190-400 nm comprises: irradiating the pre-processed leaves with the ultraviolet B rays with the wavelength in a range of 280-315 nm.

6. The method as claimed in claim 1, wherein in step 2, the freeze-drying comprises immersing the irradiated leaves in liquid nitrogen for drying, a temperature for the vacuum drying is in a range of 40-100°C, and drying time is in a range of 10-12. h; and a moisture content of the dried leaves is ≤ 5%.

7. The method as claimed in claim 1, wherein in step 3, the ball milling frequency is in a range of 15-20. Hz, and ball milling time is in a range of 10-60. min.

8. An adsorbent, prepared by the method as claimed in claim 1.

9. An application method of the adsorbent as claimed in claim 8, comprising:
adding the adsorbent to an aqueous solution containing the heavy metal lead and the precious metal gold, wherein a dosage of the adsorbent is in a range of 1-10 grams per liter (g/L), an initial pH value of the aqueous solution is in a range of 2-7, a pH value of the aqueous solution for removing lead ions is in a range of 5-6, a pH value of the aqueous solution for removing gold ions is in a range of 2-3, and initial concentrations of the lead ions and the gold ions in the aqueous solution are individually in a range of 100-800 milligrams per liter (mg/L).

10. The application method of the adsorbent as claimed in claim 9, wherein the initial concentrations of the lead ions and the gold ions in the aqueous solution are individually 200 mg/L, and a temperature of the aqueous solution is 10-100°C; and
wherein the application method further comprises: stirring at a speed in a range of 200-1000 revolutions per minute (r/min) when adding the adsorbent to the aqueous solution.
